(19) United States
(12) Patent Application Publication
(10) Pub. No.: US 2016/0053534 A1
(43) Pub. Date: Feb. 25, 2016

(54) WINDOW BLIND AND LIFT CONTROL MODULE OF COVERING STRUCTURE THEREOF

(71) Applicant: NIEN MADE ENTERPRISE CO., LTD., TAICHUNG CITY (TW)

(72) Inventor: CHIH-YAO CHANG, TAICHUNG (TW)

(21) Appl. No.: 14/789,747

(22) Filed: Jul. 1, 2015

(30) Foreign Application Priority Data
Aug. 19, 2014 (CN) 201420468475.9

(51) Int. Cl. E06B 9/322; E06B 9/68

(52) U.S. Cl. CPC E06B 9/322; E06B 9/68

(57) ABSTRACT

A lift control module of a covering structure of a window blind is provided, which is received inside a headrail of the window blind to drive at least one lifting cord to lift or lower a bottom rail. The lift control module includes an output shaft and at least one rotation shaft, which are arranged along different axes. The lift control module is compatible with various kinds of window blinds, for different requirements may be satisfied by controlling the reeling of the at least one lifting cord through one or two rotation shafts.

The current application claims a foreign priority to application number 201420468475.9 filed on Aug. 19, 2014 in China.

### BACKGROUND OF THE INVENTION

1. Technical Field

The present invention relates generally to a window covering, and more particularly to a window blind and a lift control module of a covering structure thereof.

2. Description of Related Art

As shown in FIG. 1, a conventional lifting controlling mechanism of a window blind includes a driving cord 1 and a controller 2. The controller 2 is drivable by operating the driving cord 1 to tilt slats 3. When the driving cord 1 is pulled continuously to overcome a friction provided by a spring 2a of the controller 2, the controller 2 can lift or lower a bottom rail (not shown).

The controller 2 has both functions of lifting the window blind and tilting the slats 3. However, a closure tightness of slats 3 depends on a stiffness of the spring 2a. That is, if the stiffness of the spring 2a is higher, the closure tightness of the slats 3 is higher as well, but high stiffness also causes a large resistance for lifting the bottom rail. On the contrary, lower stiffness of the spring 2a produces a small resistance for lifting the bottom rail, but the slats 3 would consequently have lower closure tightness. In addition, the slats 3 of the aforementioned conventional window blind are provided with apertures 3a for lifting cords 4 to pass through. These apertures 3a may cause some problems. For example, light may leak through these apertures 3a when the window blind is in a closed state which is supposed to completely cover a window, and the lifting cords 4 and the edges of the apertures 3a may have unnecessary frictions generated therebetween.

U.S. patent application 2014/0014279 discloses a lifting controlling system of a window covering. The window covering includes a plurality of slats arranged in parallel between a headrail and a bottom rail. Four lift drums are received in the headrail, and reel in or out two lifting cords of the window covering for lifting or lowering the bottom rail. The lift drums are arranged in two sets, and each of the two sets includes two lift drums. In each set, each of the lift drums is connected to a gear, and the gears are meshed mutually.

The two sets of the lift drums are located at two ends of the headrail respectively, and wherein one lift drum of the both set are penetrated by one single hexagonal shaft. The hexagonal shaft is drivable by a spring motor to synchronously rotate the two lift drums which are penetrated by it. By means of meshing and force transmission of the gears, the lift drums in one set rotate in opposite directions. Whereby, the lift drums reel in or out the two lifting cords synchronously.

However, with the aforementioned design, the loading of the spring motor would be heavy while lifting or lowering the bottom rails and the slats, which may cause the operation unable to be performed smoothly.

### BRIEF SUMMARY OF THE INVENTION

In view of the above, the primary objective of the present invention is to provide a window blind and a lift control module thereof. The window blind has a tilting device and a lifting device installed independently, which provides an efficient way for operation in an effortless way.

The present invention provides a lift control module of a covering structure of a window blind, wherein the window blind includes a headrail to receive the lift control module therein, at least one lifting cord to be reeled in or out by the lift control module, and a bottom rail to be lifted or lowered by the at least one lifting cord. The lift control module includes a first lift drum, a second lift drum, a first rotation shaft and a second rotation shaft. The first lift drum is connected to an end of the at least one lifting cord; the second lift drum is connected to another end of the at least one lifting cord; the first rotation shaft is connected to the first lift drum; the second rotation shaft is connected to the second lift drum. The first lift drum and the second lift drum are parallel to each other, and the first rotation shaft and the second rotation shaft are parallel to each other; the first lift drum and the second lift drum are drivable by the first rotation shaft and the second rotation shaft respectively to rotate in the same direction synchronously.

In an embodiment, the lift control module further includes s a first driven wheel, a second driven wheel, and a controller which includes an output shaft and a driving wheel. The output shaft is controllable to rotate, and is connected to the driving wheel with an end thereof. An end of the first rotation shaft is connected to the first driven wheel, which meshes with the driving wheel. An end of the second rotation shaft is connected to the second driven wheel, which meshes with the driving wheel.

In an embodiment, the controller includes s a disk and a driving cord. The disk is connected to the output shaft; the driving cord surrounds an outer edge of the disk, and is controllable to drive the disk to rotate.

In an embodiment, the lift control module further includes a side cover installed on a side of the headrail. A plurality of cylinders are provided on an inner surface of the side cover, and at least a portion of an outer surface of each of the cylinders is a curved surface. The disk is connected to the inner surface of the side cover, and a gap is formed between the outer edge of the disk and the cylinders. A segment of the driving cord is located in the gap to abut against the curved surfaces of the cylinders, and another segment of the driving cord is exposed out of the headrail.

In an embodiment, the inner surface of the side cover has a plurality of columns provided thereon. The cylinders are hollow to fit around the columns correspondingly; each of the cylinders is rotatable relative to the inner surface of the side cover.

The present invention further provides a lift control module of a covering structure of a window blind, wherein the window blind includes s a headrail to receive the lift control module therein, a first lifting cord to be driven by the lift control module, and a bottom rail to be lifted or lowered by the first lifting cord. The lift control module includes a first driven wheel, a first controller and a first rotation shaft. The first controller is located on a side of the headrail, and includes a first output shaft and a first driving wheel which meshes with the first driven wheel. The first output shaft is controllable to rotate, and is connected to the first driving wheel with an end thereof. The first rotation shaft is connected to an end of the first lifting cord, wherein an end of the first rotation shaft is connected to the first driven wheel. The first rotation shaft and the first output shaft are respectively arranged along two different axes.

In an embodiment, the window blind includes a second lifting cord and a middle rail located between the headrail and the bottom rail, and the middle rail is drivable by the second lifting cord. The lift control module further includes a second driven wheel, a second controller and a second rotation shaft. The second controller is provided on another side of the headrail, and includes a second output shaft and a second driving wheel. The second output shaft is controllable to rotate, and is connected to the second driving wheel with an end thereof. The second rotation shaft is connected to an end of the second lifting cord, wherein an end of the second rotation shaft is connected to the second driven wheel, which meshes with the second driving wheel. The second rotation shaft and the second output shaft are arranged along two parallel axes.

In an embodiment, the controller includes a first disk and a first driving cord. The first disk is connected to the first output shaft; the first driving cord surrounds an outer edge of the first disk, and is controllable to drive the first disk to rotate. The second controller includes a second disk and a second driving cord, wherein the second disk is connected to the second output shaft. The second driving cord surrounds an outer edge of the second disk, and is controllable to drive the second disk to rotate.

In an embodiment, the lift control module further includes a first side cover and a second side cover, wherein the first side cover is installed on a side of the headrail, and the second side cover is installed on another side of the headrail. A plurality of cylinders are provided on inner surfaces of the first side cover and the second side cover, and at least a portion of an outer surface of each of the cylinders is a curved surface. The first disk is connected to the inner surface of the first side cover, and the second disk is connected to the inner surface of the second side cover. A segment of the first driving cord and a segment of the second driving cord abut against the curved surfaces of the cylinders, while another segment of the first driving cord and another segment of the second driving cord are exposed out of the headrail.

In an embodiment, the inner surfaces of the first side cover and the second side cover have a plurality of columns provided thereon. The cylinders are hollow to fit around the columns correspondingly. Each of the cylinders is rotatable relative to the inner surfaces of the first side cover and the second side cover.

In an embodiment, the lift control module further includes a second driven wheel and a second rotation shaft. The second rotation shaft is connected to an end of the first lifting cord, and an end of the second rotation shaft is connected to the second driven wheel, which meshes with the first driving wheel. The first rotation shaft, the second rotation shaft and the first output shaft are respectively arranged along three parallel axes.

In an embodiment, the first controller includes a first disk and a first driving cord. The first disk is connected to the first output shaft; the first driving cord surrounds an outer edge of the first disk, and is controllable to drive the first disk to rotate.

In an embodiment, the lift control module further includes a first side cover, wherein the first side cover is installed on a side of the headrail. A plurality of cylinders are provided on an inner surface of the first side cover, and at least a portion of an outer surface of each of the cylinders is a curved surface. The first disk is connected to the inner surface of the first side cover; a gap is formed between the outer edge of the first disk and the cylinders. A segment of the first driving cord abuts against the curved surfaces of the cylinders, while another segment of the first driving cord is exposed out of the headrail.

In an embodiment, the inner surface of the first side cover has a plurality of columns provided thereon. The cylinders are hollow to fit around the columns correspondingly; each of the cylinders is rotatable relative to the inner surface of the first side cover.

The present invention further provides a lift control module of a covering structure of a window blind, wherein the window blind includes a headrail to receive the lift control module therein, at least one lifting cord to be reeled in or out by the lift control module. The lift control module includes a side cover, a disk, a driving cord and a rotation shaft. The side cover is installed on a side of the headrail. A plurality of cylinders are provided on an inner surface of the side cover, and at least a portion of an outer surface of each of the cylinders is a curved surface. The disk is connected to the inner surface of the side cover; a gap is formed between an outer edge of the disk and the cylinders The driving cord surrounds the outer edge of the disk, wherein a segment of the driving cord abuts against the curved surfaces of the cylinders, and another segment of the driving cord is exposed outside the headrail. The rotation shaft is connected to an end of the at least one lifting cord; wherein the rotation shaft reels in or out the at least one lifting cord along with the rotation of the disk.

In an embodiment, the lift control module further includes a driven wheel and a controller. The controller has an output shaft and a driving wheel; an end of the output shaft is connected to the disk, and another end of the output shaft is connected to the driving wheel. An end of the rotation shaft is connected to the driven wheel which meshes with the driving wheel; the rotation shaft and the output shaft are respectively arranged along two parallel axes.

In an embodiment, the inner surface of the side cover has a plurality of columns provided thereon. The cylinders are hollow to fit around the columns correspondingly; each of the cylinders is rotatable relative to the inner surface of the side cover.

The present invention further provides a window blind, which includes a headrail, a bottom rail, a plurality of slats, a ladder rope, a first lift control module and an adjusting device. The plurality of slats are arranged between the headrail and the bottom rail. The ladder rope supports the slats. The first lift control module is further includes a first lift control module and an adjusting device. The first lift control module is received in one side of the headrail, and includes a first output shaft, a first rotation shaft and a first lifting cord. The first output shaft and the first rotation shaft are respectively arranged along two different axes. An end of the first lifting cord is connected to the first rotation shaft, while another end of the first lifting cord is connected to the bottom rail. The first output shaft is controllable to drive the first rotation shaft to reel in or out the first lifting cord The adjusting device includes at least one ladder drum received in the headrail, wherein the at least one ladder drum is connected to an end of the ladder rope, and another end of the ladder rope is connected to the bottom rail. The at least one ladder drum is controllable to rotate for driving the ladder rope to tilt the slats.

In an embodiment, the window blind further includes a middle rail and a second lift control module, wherein the middle rail is provided between the headrail and the bottom rail, and the slats are arranged between the middle rail and the bottom rail. The second lift control module is received on another side of the headrail, and includes a second output shaft, a second rotation shaft and a second lifting cord. The second output shaft and the second rotation shaft are respectively arranged along two parallel axes. An end of the second lifting cord is connected to the second rotation shaft, and another end of the second lifting cord is connected to the middle rail. The second output shaft is controllably drivable to rotate the second rotation shaft for reeling in or out the second lifting cord. The ladder rope includes a ladder and two side ropes, wherein an end of each of the two side ropes is fixed to one of the at least one ladder drum, and another end of each of the two side ropes is fixed to the bottom rail. The ladder includes two parallel warps and a plurality of wefts connected to the two warps, wherein an end of each of the two warps is fixed to the middle rail, and another end of each of the two warps is fixed to the bottom rail. The slats are provided between the two wraps, and each of the slats respectively lies on each of the wefts.

In an embodiment, the first lift control module includes a disk and a driving cord. The disk is connected to the first output shaft; the driving cord surrounds an outer edge of the disk. The driving cord controllably drives the disk to rotate.

Whereby, the lift control module of the present invention is compatible with various kinds of window blinds because of the parallel relation between the output shaft and the rotation shaft. In other words, the reeling of the at least one lifting cord may be controlled by one or two rotation shafts. Moreover, the driving cord may be pulled easily because the driving cord abuts against the curved surfaces of the rotatable cylinders.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the conventional lift control mechanism of the conventional window blind;

FIG. 2 is a perspective view of a first preferred embodiment of the present invention;

FIG. 3 is a perspective view of the lift control module of FIG. 2;

FIG. 4 is a partial exploded view of FIG. 3;

FIG. 5 is a partial exploded view of the lift control module of the first preferred embodiment, showing the relation between the side cover and the controller;

FIG. 6 is a partial side view of the controller of the first preferred embodiment, showing the relation among the driving cord, the cylinder and the disk of the controller;

FIG. 7 is a perspective view of the first preferred embodiment, showing the base of the lift control module;

FIG. 8 is a partial schematic diagram of the first preferred embodiment, showing the relation among the lifting cord, the first lift drum and the second lift drum;

FIG. 9 is a perspective view of a second preferred embodiment of the present invention;

FIG. 10 is a top view of the lift control module of FIG. 9;

FIG. 11 is a perspective view of a third preferred embodiment of the present invention;

FIG. 12 is a top view of the lift control module of FIG. 11;

FIG. 13 is a partial schematic diagram of the third preferred embodiment, showing the end of the lifting cord is connected to the bottom rail;

FIG. 14 is a partial schematic diagram of the third preferred embodiment, showing the bottom rail is lifted toward the headrail;

FIG. 15 is a partial schematic diagram of the third preferred embodiment, showing the end of the lifting cord is connected to the middle rail;

FIG. 16 is a partial schematic diagram of the third preferred embodiment, showing the middle rail is lowered from the headrail;

FIG. 17 is a partial exploded view of the fourth preferred embodiment, showing the output shaft of the controller is vertical to the rotation shaft; and

FIG. 18 is a perspective view of the fifth preferred embodiment, showing the window blind includes both the slat type covering and the honeycomb type covering.

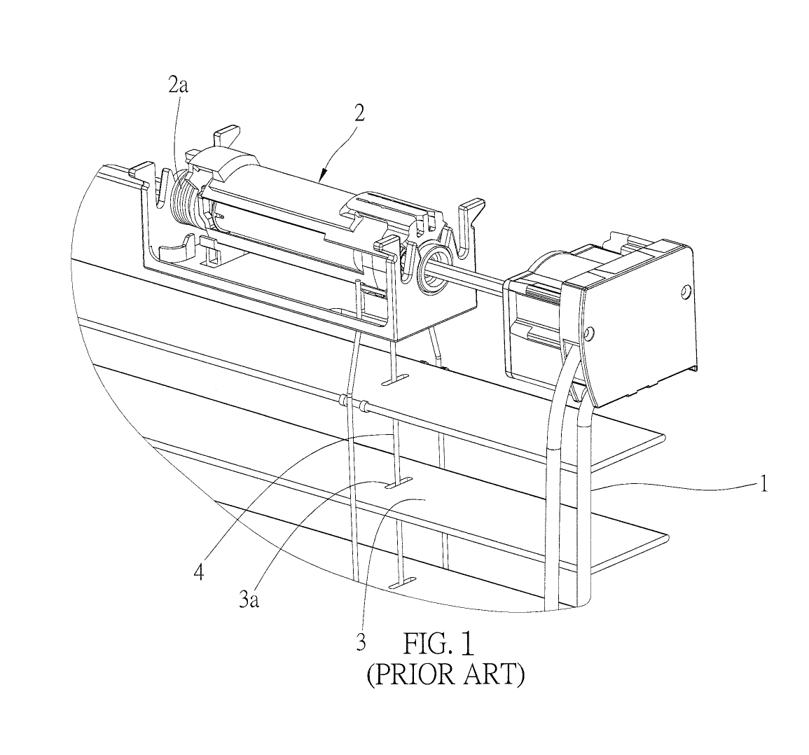

### DETAILED DESCRIPTION OF THE INVENTION

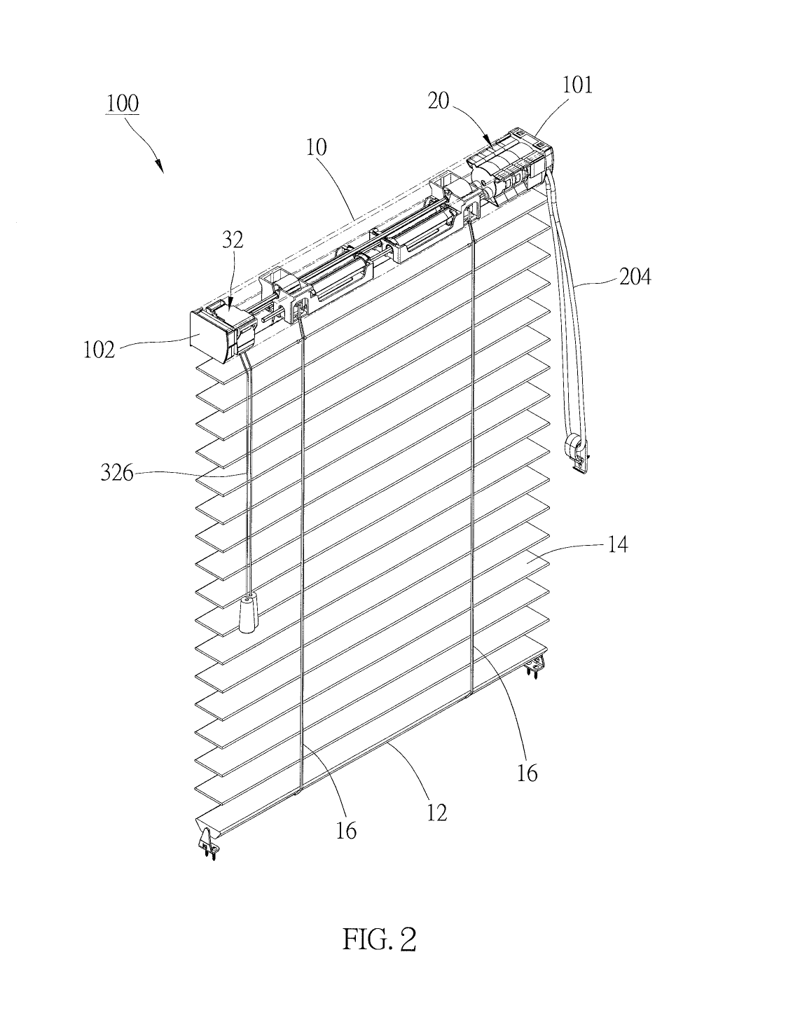

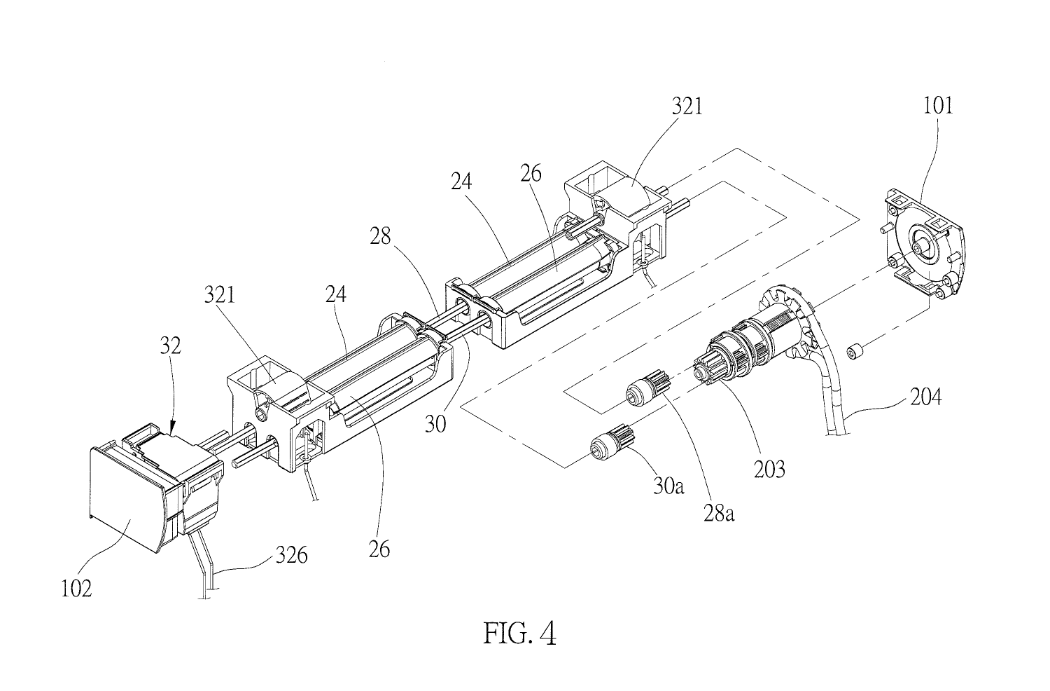

As shown in FIG. 2 to FIG. 4 and FIG. 8, a window blind 100 of the first preferred embodiment of the present invention includes a headrail 10, a bottom rail 12, a plurality of slats 14, two ladder ropes 16, and two lifting cords 18. The two ladder ropes 16 support the slats 14. The two lifting cords 18 are controllable to lift or lower the bottom rail 12. In the present embodiment, the window blind 100 includes a controller 20, two bases 22, two first lift drums 24, two second lift drums 26, a first rotation shaft 28, a second rotation shaft 30, and an adjusting device 32, which are all received inside the headrail 10. The two lifting cords 18, the controller 20, the two bases 22, the two first lift drums 24, the two second lift drums 26, the first rotation shaft 28, and the second rotation shaft 30 given above constitute a lift control module. The window blind 100 includes a covering structure to cover a window, wherein the covering structure in the first preferred embodiment is the slats 14, but may be different design or components in other embodiments.

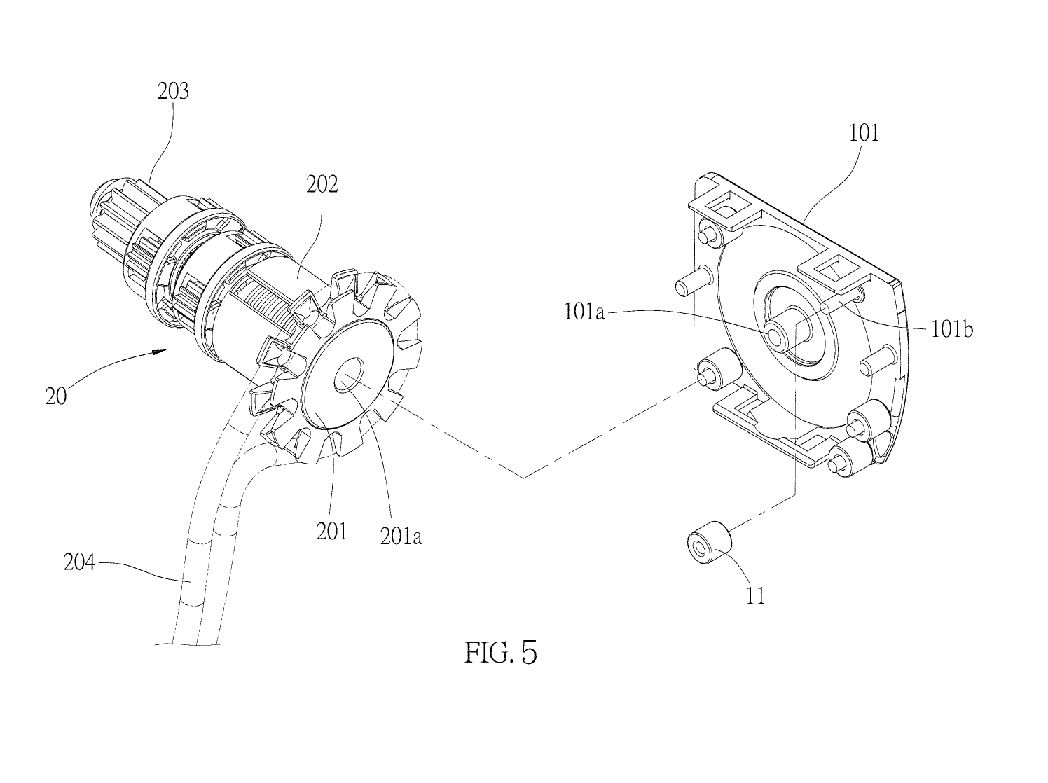

Two ends of the headrail 10 are connected to a first side cover 101 and a second side cover 102 respectively. As shown in FIG. 5, a center shaft 101a is located at the center of an inner surface of the first side cover 101, and a plurality of columns 101b are provided around the center shaft 101a on the inner surface of the first side cover 101. In addition, a plurality of hollow cylinders 11 are fitted around the columns 101b correspondingly, and each of the cylinders 11 may rotate relative to the inner surface of the first side cover 101.

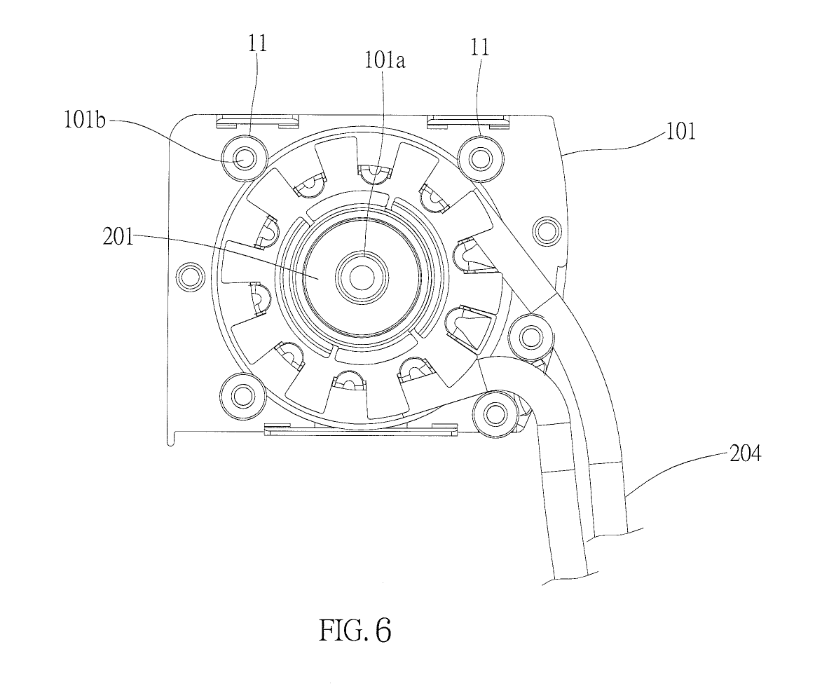

The controller 20 includes a disk 201, an output shaft 202, a driving wheel 203, and a driving cord 204. The disk 201 has an axial pore 201a, which allows the center shaft 101a of the first side cover 101 to pass through. The disk 201 is rotatable and is connected to the inner surface of the first side cover 101. A gap is formed between an outer edge of the disk 201 and the cylinders 11. The output shaft 202 consists of a plurality of transmission members, wherein the output shaft 202 connects the disk 201 with an end thereof, and connects the driving wheel 203 with another end. As shown in FIG. 6, a segment of the driving cord 204 surrounds the outer edge of the disk 201, and the segment of the driving cord 204 is located in the gap to abut against the curved surface of the cylinders 11. Therefore, the segment of the driving cord 204 which is located in the gap may be restricted therein, and a rest segment of the driving cord 204 is exposed outside the headrail 10 to be controlled. In addition, the driving cord 204 outside the headrail 10 further includes two sections; by pulling the two different sections of the driving cord 204, the disk 201 may rotate in opposite directions, the output shaft 202 and the driving wheel 203 are jointly driven to rotate in opposite directions as well. The driving cord 204 mentioned above is not limited to be a cord, but may be a bead chain in other embodiments. The contact areas of the driving cord 204 and the cylinders 11 are as small as a point, which decreases a resistance between the driving cord 204 and the cylinders 11. In addition, the cylinders 11 are rotatable, thus the driving cord 204 may be able to be easily pulled by users.

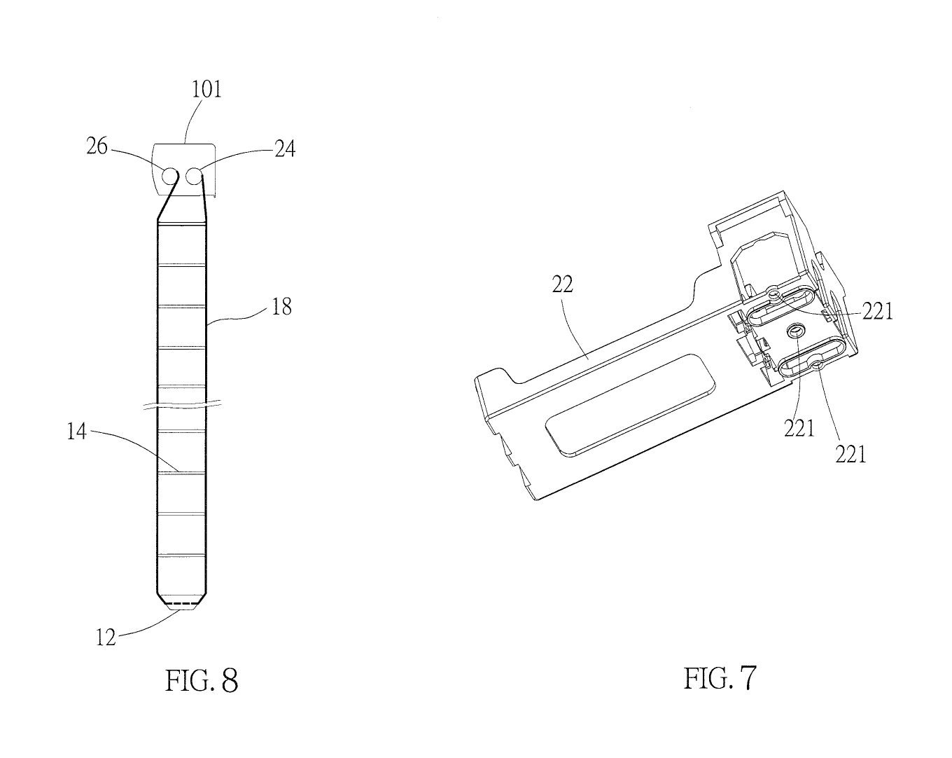

The two bases 22 are received at a left side and a right side of the headrail 10 respectively. Each of the two bases 22 has one of the first lift drums 24 and one of the second lift drums 26 installed thereon, wherein the first lift drum 24 and the second lift drum 26 installed on each of the two bases 22 are arranged in parallel. As shown in FIG. 7 and FIG. 8, each of the two bases 22 has three holes 221 at the bottom thereof. Two ends of each of the lifting cords 18 respectively pass through two of the three holes 221 and are connected to the same side of the first lift drum 24 and the second lift drum 26. In the first preferred embodiment, a segment of each of the lifting cords 18 passes around the bottom rail 12, and another segment of each of the lifting cords 18 is provided on the front side of the slats 14, while the rest segment of each of the lifting cords 18 is provided on a back side of the slats 14. In other words, each of the lifting cords 18 forms a U-shape to surround the slats 14 without passing through the slats 14. In practice, an end of each of the lifting cords 18 may also be fixed to the headrail 10 or the base 22, while another end of each of the lifting cords 18 is fixed to the first lift drum 24 or the second lift drum 26. The slats 14 given above have no apertures thereon, and therefore provide a better shading effect. Additionally, each of the lifting cords 18 may consist of two independent ropes, wherein bottom ends of the two independent ropes are fixed to the bottom rail 12, and upper ends of the two independent ropes are fixed to the first lift drum 24 and the second lift drum 26 respectively.

The first rotation shaft 28 and the second rotation shaft 30 are hexagonal shafts arranged in parallel. The first rotation shaft 28 penetrates the two first lift drums 24, and an end of the first rotation shaft 28 is connected to a first driven wheel 28a; the second rotation shaft 30 penetrates the two second lift drums 26, and an end of the second rotation shaft 30 is connected to a second driven wheel 30a. Both the first driven wheel 28a and the second driven wheel 30a mesh with the driving wheel 203 of the controller 20, wherein the first rotation shaft 28, the second rotation shaft 30, and the output shaft 202 are parallel to each other. In other words, while the driving wheel 203 is rotated by the control of the driving cord 204, both the first driven wheel 28a and the second driven wheel 30a rotate in the same direction synchronously. Consequently, the first rotation shaft 28 and the second rotation shaft 30 drive the first lift drums 24 and the second lift drums 26 to rotate in the same direction for reeling in or out the two lifting cords 18, which achieves an objective of lifting or lowering the bottom rail 12.

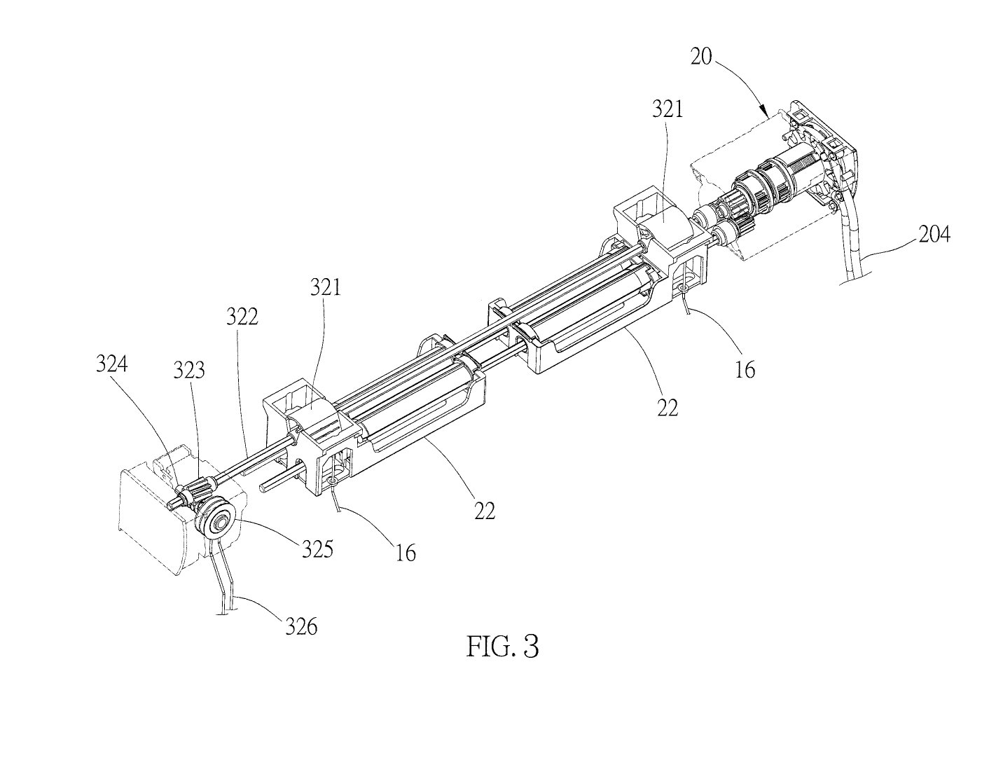

The adjusting device 32 includes two ladder drums 321, a transmission shaft 322, a worm gear 323, a worm 324, a reel 325, and a pull cord 326. As shown in FIG. 3, each of the two ladder drums 321 is rotatable and is installed in each of the bases 22, and the two ladder drums 321 are arranged along an axis. An end of each of the ladder ropes 16 is fixed to a ladder drum 321. The transmission shaft 322 is a hexagonal shaft, and penetrates the two ladder drums 321. An end of the transmission shaft 322 is connected to the worm gear 323, wherein the worm gear 323 meshes with the worm 324, and an end of the worm 324 is connected to the reel 325. The reel 325 is drivable by the pull cord 326 to rotate, and jointly drives the transmission shaft 322 to rotate. Whereby, the ladder ropes 16 are reeled in or out, and the slats 14 supported by the ladder ropes 16 are tilted consequently so as to shade or not to shade the window.

In conclusion, the single controller 20 provided in the window blind 100 drives the first rotation shaft 28 and the second rotation shaft 30 to rotate synchronously. Furthermore, the controller 20 drives rotation of all lift drums 24, 26 and movement of the lifting cords 18, which makes users be able to pull the driving cord 204 in an effortless way. Additionally, the adjusting device 32 and the lift control module are installed independently in the headrail, and can be easily operated. Compare with a window blind including the conventional lifting controlling mechanism, the window blind 100 not only enhances the closure tightness of the slats 14, but also makes operation become easier.

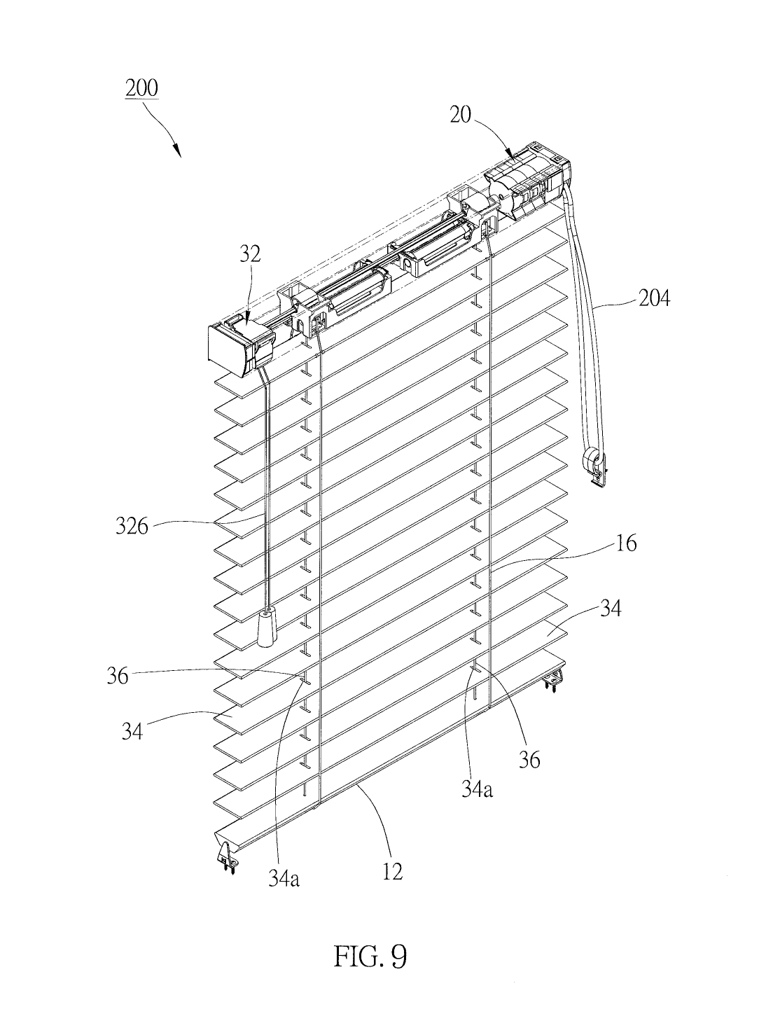

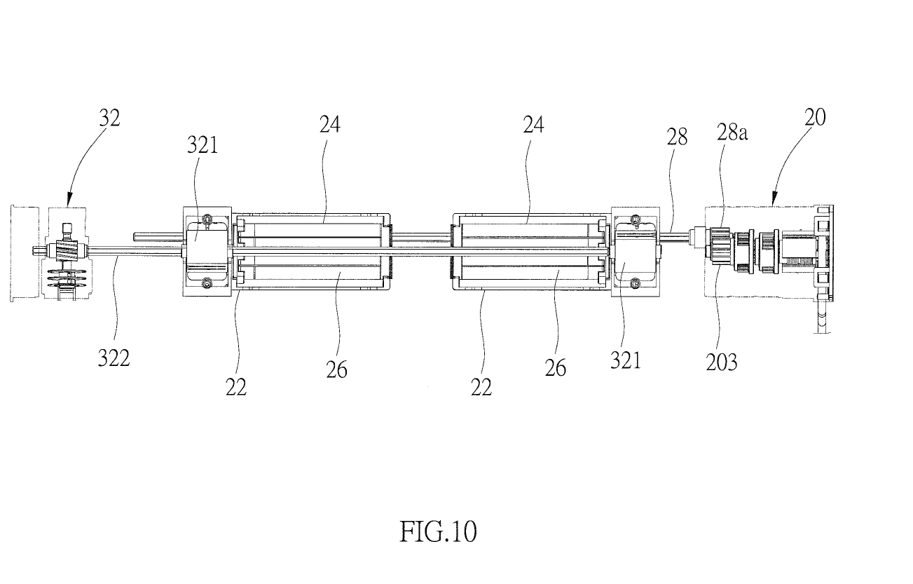

As shown in FIG. 9 and FIG. 10, a window blind 200 of the second preferred embodiment of the present invention includes the most of the structures of the window blind 100, including a plurality of slats 34 and two lifting cords 36. The difference between the window blinds 100 and 200 is that, the window blind 200 is not provided with the second rotation shaft 30. In the second preferred embodiment, each of slats 34 has two elongated apertures 34a. An end of each of the lifting cords 36 is fixed to one of the first lift drums 24, and a segment of each of the lifting cords 36 passes through the headrail 10 and the apertures 34a, while another end of each of the lifting cords 36 is fixed to the bottom rail 12. Whereby, the driving wheel 203 may be driven to rotate by pulling the driving cord 204, and the first rotation shaft 28 is also consequently driven to steer the two first lift drums 24 for reeling in or out the two lifting cords 36. With such design, users may control the window blind 200 to a closed state or an open state.

The window blind 200 is still controllable even though its lift control module has no second rotation shaft 30. On the contrary, the lift control module is compatible with various kinds of window blinds, that is to say, whether the slats have apertures or not.

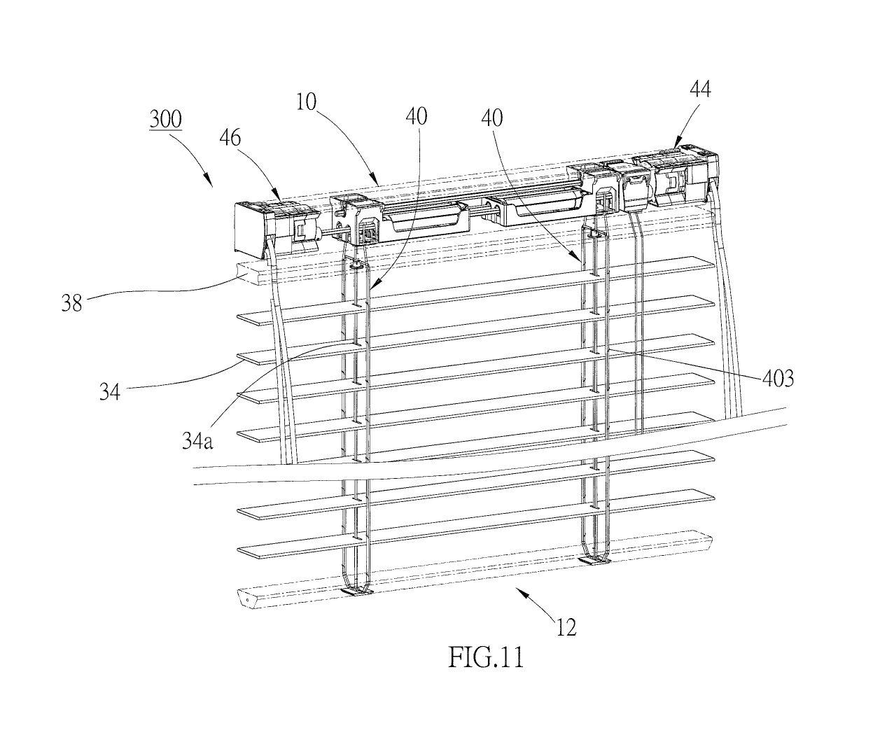

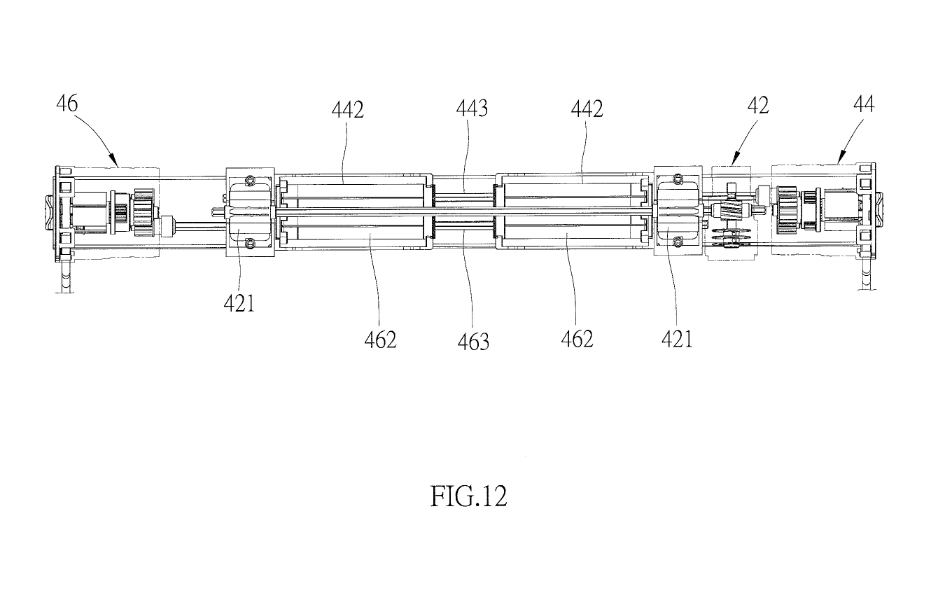

As shown in FIG. 11 and FIG. 12, a window blind 300 of the third preferred embodiment of the present invention includes the most of the structures of the window blind 200, including a plurality of slats 34, a ladder rope 40 and an adjusting device 42. A difference between the window blind 200 and 300 is that the window blind 300 includes a middle rail 38. The middle rail 38 is provided between the headrail 10 and the bottom rail 12. Moreover, the slats 34 are arranged between the middle rail 38 and the bottom rail 12.

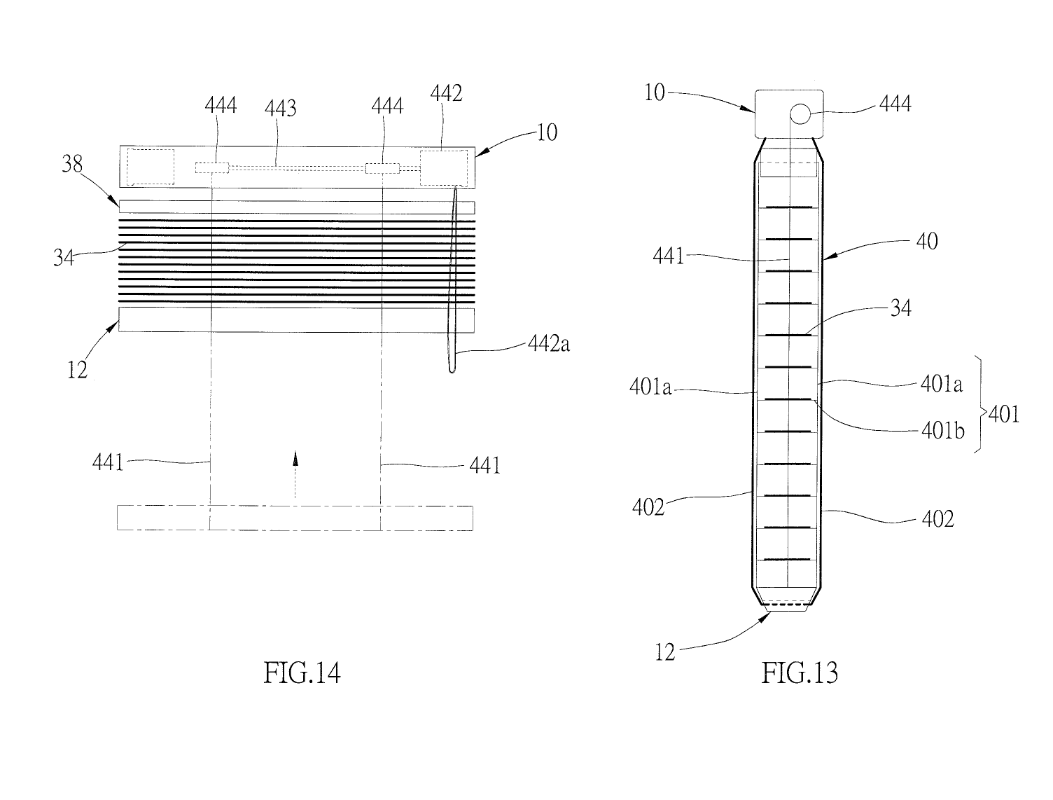

As shown in FIG. 12 and FIG. 13, the ladder rope 40 includes a ladder 401 and two side ropes 402, wherein an end of each of the side ropes 402 is fixed to a ladder drum 421 of the adjusting device 42, while another end of each of the side ropes 402 is fixed to the bottom rail 12. The ladder 401 includes two warps 401a in parallel and a plurality of wefts 401b connecting with the two warps 401a. An end of each of the warps 401a is fixed to the middle rail 38, and another end of each of the warps 401a is fixed to the bottom rail 12. Each of the warps 401a is joined with the adjacent side rope 402 through a plurality of rings 403. Each of the slats 34 is provided between the two warps 401a, and lies on one of the wefts 401b. Whereby, the adjusting device 42 may tilt the slats 34.

Additionally, the window blind 300 further includes two lift control modules, a first lift control module 44 and a second lift control module 46. As shown in FIG. 13 and FIG. 14, the first lift control module 44 includes two first lifting cords 441, a first controller 442, a first rotation shaft 443, and two first lift drums 444. An end of each of the first lifting cords 441 is connected to one of the first lift drums 444, and a segment of the first lift cord 441 penetrates the middle rail 38 and passes through the apertures 34a of the slats 34; while another end of each of the first lift cords 441 is connected to the bottom rail 12. By pulling a first driving cord 442a of the first controller 442, the first rotation shaft 443 may be driven as well as the two first lift drums 444 to reel the two first lifting cords 441. The first lift control module 44 controls the movement of the bottom rail 12 relative to the headrail 10, wherein the bottom rail 12 is lifted to make the window blind 300 in an open state.

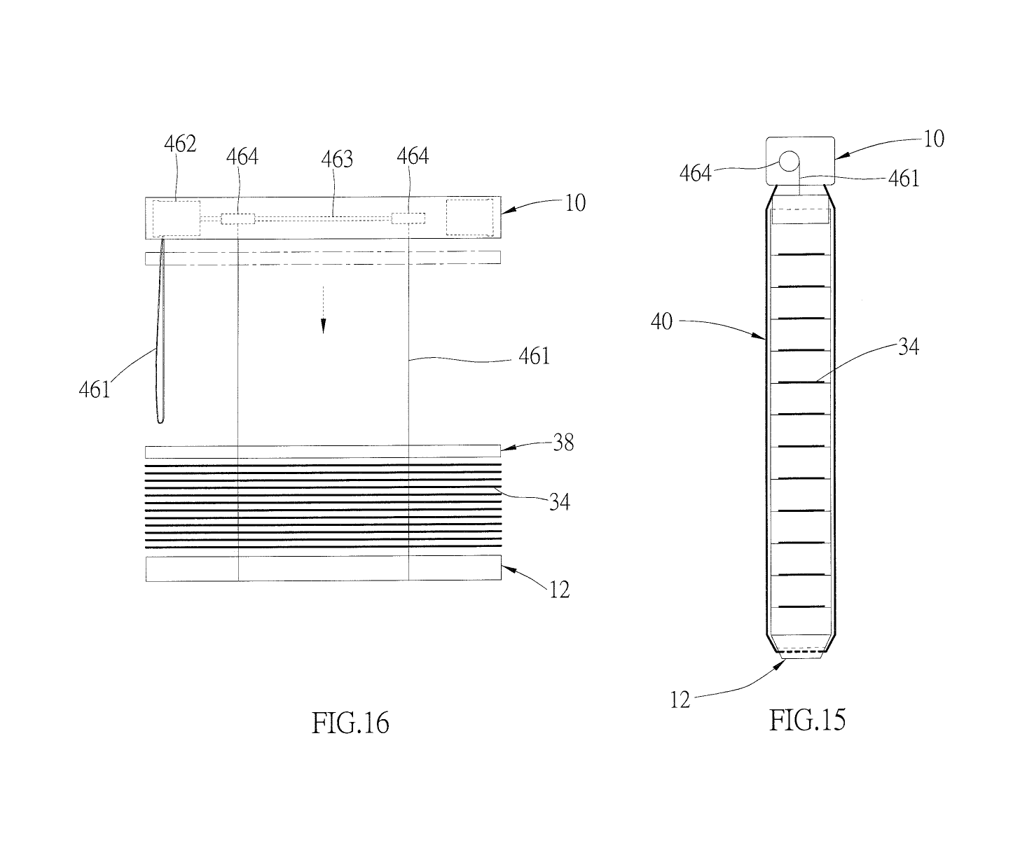

As shown in FIG. 15 and FIG. 16, the second lift control module 46 includes two second lifting cords 461, a second controller 462, a second rotation shaft 463, and two second lift drums 464. A difference between the second lift control module 46 and the first lift control module 44 is that an end of each of the second lifting cord 461 is fixed to the one of the second lift drum 464, while another end of each of the second lifting cord 461 is fixed to the middle rail 38. By pulling a second driving cord 462a of the second controller 462, the second rotation shaft 463 is driven as well as the two second lift drums 464 to reel the two second lifting cords 461. The second lift control module 46 controls the movement of the middle rail 38 relative to the headrail 10, wherein the middle rail 38 is lowered to make the window blind 300 in an open state. In the third preferred embodiment, the middle rail 38 is a board-shape beam; however, the middle rail 38 may be a slat 34 in practice.

A relation between the ladder 401 and the slats 34 makes the adjusting device 42 tilt the slats 34 smoothly rather than influenced by the first lift control module 44 and the second lift control module 46. Additionally, the first driving cord 442a and the second driving cord 462a abut against the curved surface of the cylinders 11 (not shown), which makes the driving cords easier to be pulled.

The lift control module of the present invention is compatible with various kinds of window blinds because of the parallel relation between the output shaft 50 and the rotation shaft 52. In other words, the reeling of the lifting cords may be controlled by one or two rotation shafts.

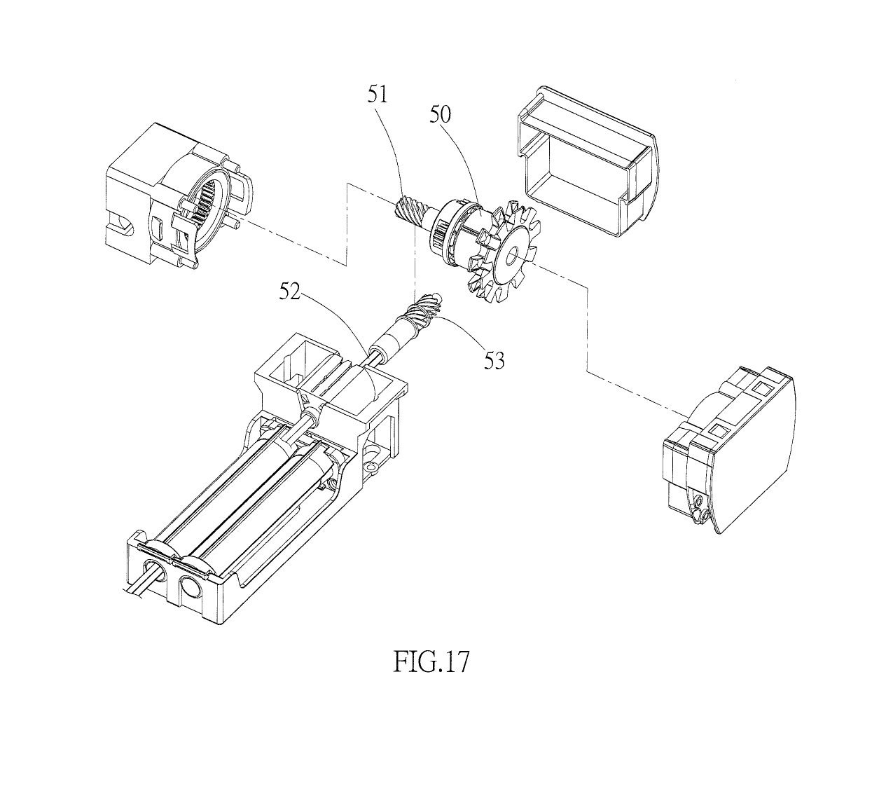

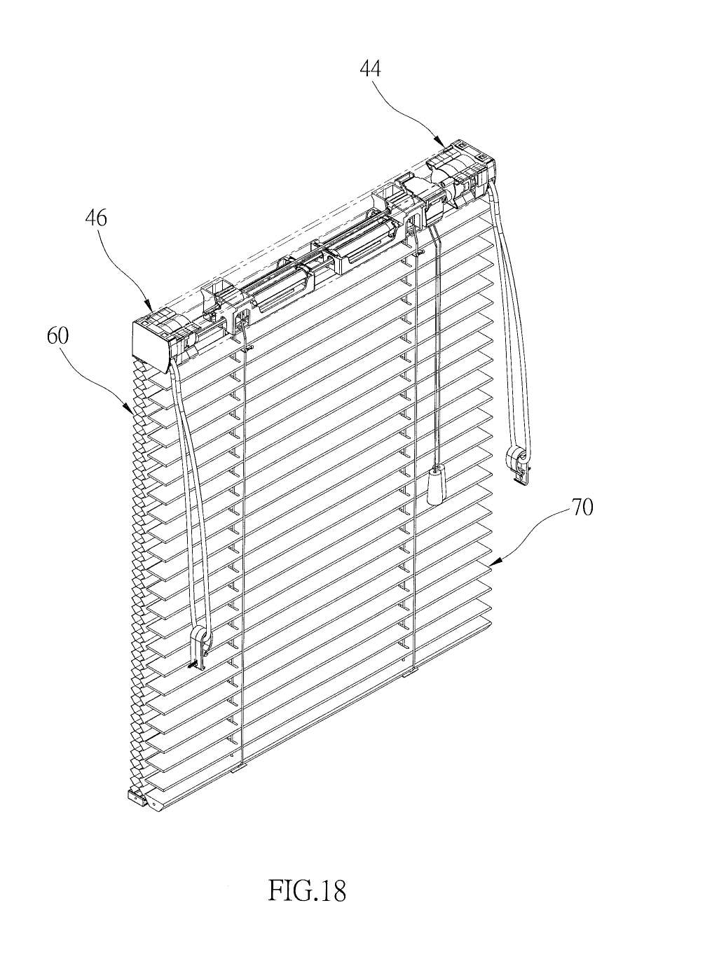

However, in practice, the output shaft 50 and the rotation shaft 52 may not be arranged in parallel. As shown in FIG. 17, an output shaft 50 of a controller and a rotation shaft 52 are vertical to each other, thus a driving wheel 51 of the controller and a driven wheel 53 are vertical to each other as well. In this case, the controller may also provide the effect of power transmission.

Moreover, in each of the aforementioned embodiments, each of the lifting cords is linked to the rotation shaft by connecting to the lift drum. However, in other embodiments, a lifting cord may be connected to the rotation shaft directly.

In addition, based on the technical concept in each of the aforementioned embodiments, a window blind may be the example shown in FIG. 18. The window blind includes a first covering 60 and a second covering 70 under the headrail. In this embodiment, the first covering 60 is a honeycomb type covering, but this is not a limitation of the present invention; the second covering 70 is a slat type covering, but this is not a limitation of the present invention either. The first lift control module 44 and the second lift control module 46 shown in FIG. 11 to FIG. 16 control the movements of the first covering 60 and the second covering 70 respectively. Therefore, consumers may select the window blind in distinctive style which consists of different coverings of different types.

It must be pointed out that the embodiments described above are only some preferred embodiments of the present invention. All equivalent structures which employ the concepts disclosed in this specification and the appended claims should fall within the scope of the present invention.

What is claimed is:

1. A lift control module of a covering structure of a window blind, wherein the window blind comprises a headrail to receive the lift control module therein, at least one lifting cord to be reeled in or out by the lift control module, and a bottom rail to be lifted or lowered by the at least one lifting cord, comprising:
a first lift drum connected to an end of the at least one lifting cord;
a second lift drum connected to another end of the at least one lifting cord;
a first rotation shaft connected to the first lift drum; and
a second rotation shaft connected to the second lift drum;
wherein the first lift drum and the second lift drum are parallel to each other, and the first rotation shaft and the second rotation shaft are parallel to each other; the first lift drum and the second lift drum are drivable by the first rotation shaft and the second rotation shaft respectively to rotate in the same direction synchronously.

2. The lift control module of claim 1, further comprising a first driven wheel, a second driven wheel, and an controller comprising an output shaft and a driving wheel, wherein the output shaft is controllable to rotate, and is connected to the driving wheel with an end thereof; an end of the first rotation shaft is connected to the first driven wheel, which meshes with the driving wheel; an end of the second rotation shaft is connected to the second driven wheel, which meshes with the driving wheel.

3. The lift control module of claim 2, wherein the controller comprises a disk and a driving cord; the disk is connected to the output shaft; the driving cord surrounds an outer edge of the disk, and is controllable to drive the disk to rotate.

4. The lift control module of claim 3, further comprising a side cover installed on a side of the headrail; a plurality of cylinders are provided on an inner surface of the side cover, and at least a portion of an outer surface of each of the cylinders is a curved surface; the disk is connected to the inner surface of the side cover, and a gap is formed between the outer edge of the disk and the cylinders; a segment of the driving cord is located in the gap to abut against the curved surfaces of the cylinders, and another segment of the driving cord is exposed out of the headrail.

5. The lift control module of claim 4, wherein the inner surface of the side cover has a plurality of columns provided thereon; the cylinders are hollow to fit around the columns correspondingly; each of the cylinders is rotatable relative to the inner surface of the side cover.

6. A lift control module of a covering structure of a window blind, wherein the window blind comprises a headrail to receive the lift control module therein, a first lifting cord to be driven by the lift control module, and a bottom rail to be lifted or lowered by the first lifting cord, comprising:
a first driven wheel;
a first controller located on a side of the headrail, wherein the first controller comprises a first output shaft and a first driving wheel which meshes with the first driven wheel; the first output shaft is controllable to rotate, and is connected to the first driving wheel with an end thereof; and
a first rotation shaft connected to an end of the first lifting cord, wherein an end of the first rotation shaft is connected to the first driven wheel;
wherein the first rotation shaft and the first output shaft are respectively arranged along two different axes.

7. The lift control module of claim 6, wherein the window blind comprises a second lifting cord and a middle rail located between the headrail and the bottom rail, and the middle rail is drivable by the second lifting cord, further comprising:
a second driven wheel;
a second controller provided on another side of the headrail, wherein the second controller comprises a second output shaft and a second driving wheel; the second output shaft is controllable to rotate, and is connected to the second driving wheel with an end thereof; and
a second rotation shaft connected to an end of the second lifting cord, wherein an end of the second rotation shaft is connected to the second driven wheel, which meshes with the second driving wheel;
wherein the second rotation shaft and the second output shaft are arranged along two parallel axes.

8. The lift control module of claim 7, wherein the controller includes a first disk and a first driving cord; the first disk is connected to the first output shaft; the first driving cord surrounds an outer edge of the first disk, and is controllable to drive the first disk to rotate; the second controller includes a second disk and a second driving cord, wherein the second disk is connected to the second output shaft; the second driving cord surrounds an outer edge of the second disk, and is controllable to drive the second disk to rotate.

9. The lift control module of claim 8, further comprising a first side cover and a second side cover, wherein the first side cover is installed on a side of the headrail, and the second side cover is installed on another side of the headrail; a plurality of cylinders are provided on inner surfaces of the first side cover and the second side cover, and at least a portion of an outer surface of each of the cylinders is a curved surface; the first disk is connected to the inner surface of the first side cover, and the second disk is connected to the inner surface of the second side cover; a segment of the first driving cord and a segment of the second driving cord abut against the curved surfaces of the cylinders, while another segment of the first driving cord and another segment of the second driving cord are exposed out of the headrail.

10. The lift control module of claim 9, wherein the inner surfaces of the first side cover and the second side cover have a plurality of columns provided thereon; the cylinders are hollow to fit around the columns correspondingly; each of the cylinders is rotatable relative to the inner surfaces of the first side cover and the second side cover.

11. The lift control module of claim 6, further comprising a second driven wheel and a second rotation shaft, wherein the second rotation shaft is connected to an end of the first lifting cord, and an end of the second rotation shaft is connected to the second driven wheel, which meshes with the first driving wheel; wherein the first rotation shaft, the second rotation shaft and the first output shaft are respectively arranged along three parallel axes.

12. The lift control module of claim 11, wherein the first controller comprises a first disk and a first driving cord; the first disk is connected to the first output shaft; the first driving cord surrounds an outer edge of the first disk, and is controllable to drive the first disk to rotate.

13. The lift control module of claim 12, further comprising a first side cover, wherein the first side cover is installed on a side of the headrail; a plurality of cylinders are provided on an inner surface of the first side cover, and at least a portion of an outer surface of each of the cylinders is a curved surface; the first disk is connected to the inner surface of the first side cover; a gap is formed between the outer edge of the first disk and the cylinders; a segment of the first driving cord abuts against the curved surfaces of the cylinders, while another segment of the first driving cord is exposed out of the headrail.

14. The lift control module of claim 13, wherein the inner surface of the first side cover has a plurality of columns provided thereon; the cylinders are hollow to fit around the columns correspondingly; each of the cylinders is rotatable relative to the inner surface of the first side cover.

15. A lift control module of a covering structure of a window blind, wherein the window blind comprises a headrail to receive the lift control module therein, at least one lifting cord to be reeled in or out by the lift control module, comprising:
a side cover installed on a side of the headrail; a plurality of cylinders are provided on an inner surface of the side cover, and at least a portion of an outer surface of each of the cylinders is a curved surface;
a disk connected to the inner surface of the side cover; a gap is formed between an outer edge of the disk and the cylinders;
a driving cord surrounding the outer edge of the disk, wherein a segment of the driving cord abuts against the curved surfaces of the cylinders, and another segment of the driving cord is exposed outside the headrail; and
a rotation shaft connected to an end of the at least one lifting cord; wherein the rotation shaft reels in or out the at least one lifting cord along with the rotation of the disk.

16. The lift control module of claim 15, further comprising a driven wheel and a controller, wherein the controller has an output shaft and a driving wheel; an end of the output shaft is connected to the disk, and another end of the output shaft is connected to the driving wheel; an end of the rotation shaft is connected to the driven wheel which meshes with the driving wheel; the rotation shaft and the output shaft are respectively arranged along two parallel axes.

17. The lift control module of claim 15, wherein the inner surface of the side cover has a plurality of columns provided thereon; the cylinders are hollow to fit around the columns correspondingly; each of the cylinders is rotatable relative to the inner surface of the side cover.

18. A window blind comprising:
a headrail;
a bottom rail;
a plurality of slats arranged between the headrail and the bottom rail;
a ladder rope supporting the slats;
a first lift control module received in one side of the headrail, wherein the first lift control module comprises a first output shaft, a first rotation shaft and a first lifting cord; the first output shaft and the first rotation shaft are respectively arranged along two different axes; an end of the first lifting cord is connected to the first rotation shaft, while another end of the first lifting cord is connected to the bottom rail; the first output shaft is controllable to drive the first rotation shaft to reel in or out the first lifting cord; and
an adjusting device comprising at least one ladder drum received in the headrail, wherein the at least one ladder drum is connected to an end of the ladder rope, and another end of the ladder rope is connected to the bottom rail; the at least one ladder drum is controllable to rotate for driving the ladder rope to tilt the slats.

19. The window blind of claim 18, further comprising a middle rail and a second lift control module, wherein the middle rail is provided between the headrail and the bottom rail, and the slats are arranged between the middle rail and the bottom rail; the second lift control module is received on another side of the headrail, and comprises a second output shaft, a second rotation shaft and a second lifting cord, wherein the second output shaft and the second rotation shaft are respectively arranged along two parallel axes; an end of the second lifting cord is connected to the second rotation shaft, and another end of the second lifting cord is connected to the middle rail; the second output shaft is controllably drivable to rotate the second rotation shaft for reeling in or out the second lifting cord; the ladder rope comprises a ladder and two side ropes, wherein an end of each of the two side ropes is fixed to one of the at least one ladder drum, and another end of each of the two side ropes is fixed to the bottom rail; the ladder comprises two parallel warps and a plurality of wefts connected to the two warps, wherein an end of each of the two warps is fixed to the middle rail, and another end of each of the two warps is fixed to the bottom rail; the slats are provided between the two wraps, and each of the slats respectively lies on each of the wefts.

20. The window blind of claim 18, wherein the first lift control module comprises a disk and a driving cord; the disk is connected to the first output shaft; the driving cord surrounds an outer edge of the disk; the driving cord controllably drives the disk to rotate.
